(19) United States
(12) Patent Application Publication
(10) Pub. No.: US 2001/0044774 A1
(43) Pub. Date: Nov. 22, 2001

(54) Processing system and recording medium for economic data in a virtual space

(76) Inventors: Tatsuya Sasazawa, Tokyo (JP); Masatoshi Tachibana, Tokyo (JP); Takashi Saita, Tokyo (JP); Koichi Miyashita, Tokyo (JP)

Correspondence Address: CANTOR COLBURN, LLP, 55 GRIFFIN ROAD SOUTH, BLOOMFIELD, CT, 06002

(21) Appl. No.: 09/843,206

(22) Filed: Apr. 25, 2001

(30) Foreign Application Priority Data
Apr. 28, 2000 (JP) 131006/2000

(51) Int. Cl. G06F 17/60

(52) U.S. Cl. 705/39

(57) ABSTRACT

An economical data processing system, including: a means to form a virtual space in use with a network which includes a plurality of computers connected to each other; a means to form virtual currency which represents a value index in the virtual space; and a virtual currency storing means to store the virtual currency. In the economical data processing system, the virtual currency is delivered in the virtual space.

### BACKGROUND OF THE INVENTION

The present invention relates to the economic data processing system and recording medium in a virtual space wherein economic activities are conducted in a virtual space.

It has been pointed out in recent years that population is rapidly aging in recent years, and burdens on younger generation such as social insurance are increasing in Japan, Europe and the United States. One of the reasons to explain such a phenomenon is that the aged people still capable of working have not been provided with a sufficient workplace in the face of the growing number of such aged people. Even if simple physical labor is offered, they cannot make an effective use of their rich experience and knowledge. Under these circumstances, these people are gradually lose their willingness to work. Looking at the coming graying society, it is getting more important that the brain and experience of the aged people are effectively utilized to make a significant contribution to the society.

The current form of work is also limited for physically handicapped persons. Mere social insurance is not sufficient for these people to enjoy life. Even if they cannot move freely, they want to use their intelligence and knowledge to make a meaningful contribution to the community and to create social values.

In the community of the Internet, a great deal of information is provided free of charge. For example, U.S. Pat. No. 5,794,210 discloses that compensation is gained for viewing a specific screen on the network, and the compensation is used to view the screen, viewing of which requires compensation. However, description of work or foreign exchange is not included in the patent.

In recent years, it is extremely difficult for new graduates to find jobs. Even if they have got a job which is not very satisfactory, they soon find out that the work is very different from what they have anticipated, and they tend to quit the company. Such a tendency has resulted in a growing number of part timers who are making their living through irregular unspecified part time jobs. The latent creativity of these part timers is immeasurable in some cases. It is essential to solve the problem which prevent them from taking part in the activities of the communities. This also applied to the case of rapidly growing number of jobless people.

In the past, people could not always find satisfactory work. Value is a symbol of receiving compensation in an economic society. For the person creating value, this symbol is a proof demonstrating his great joy of helping others.

Previously people having a sufficient intelligence and knowledge could not find job if they could not physically move. However, if the people having a sufficient intelligence and knowledge can create values in social activities in a virtual space, they can find work to create value in a virtual space even if they cannot physically move. As a result, they can obtain compensation for their service. Namely, they can work and create value in a virtual space and virtual world. They get compensation for their creative services, and forms a society where economic activities are present in the virtual space.

The concept of virtual space provides life worth living to the people including the handicapped and aged people. It awakens their latent power to create value, and encourage them to participate in the community. In this respect, the concept of virtual space provides great advantages.

Looking at the coming society, it is extremely important to encourage creation of value in every field, to realize the latent value from the latent competence of the people without leaving it idle, and to create an opportunity to present it to the community. It is more important to present it actually, to find out a way of relating the value produced therefrom to the real world economy, and to connect between the value in economic society within the virtual space and the value real world society at an “exchange rate”.

Compensation for the work in virtual world in a virtual space can be used in the virtual space. The value does not necessarily agree with that in the real world society. The exchange value will be a reasonable value very close to the service value. Similarly to the exchange rate in the real world, electronic money used in a virtual space can be obtained in the form of services or products, thereby guaranteeing the value of work in a virtual space and improving it.

### SUMMARY OF THE INVENTION

The object of the present invention is to provide a processing system and recording medium for economic data in a virtual space which offer a place to make an effective use of the experience and knowledge of the people left unused, awaken the latent power to create value, and encourage participation into the society.

When consideration is given to a group consisting of multiple subjects exchanging information, there is much imbalance between the subjects sending much information and those receiving much information without sending much information. From the view point of impartiality, a subject sending more information has a right to receive more information. Imbalance in information exchange is unfair. This is caused by the fact that value of information is not recognized by many people. Another object of the present invention is to solve this problem, namely, to define the value of information by expressing the value of information in terms of currency value. A further object of the present invention is to make sure that information sender exchanges information with virtual currency according to the value thereof, and obtains a right to receive information, thereby ensuring partiality in the exchange of information.

Even when such an intangible asset as information is exchanged with money, much load has been needed so far for consumption of much labor and energy required for physical movement of real world money or the like. Electronic money or the like has been invented to reduce labor and load on the environment. However, the electronic money involves safety problems. To solve safety problems, encryption and many other means must be taken. This requires much cost, and this method has not been easily used. The present invention provides a system which allows value and information with value to be exchanged with small labor and much safety and reliability, without giving much load to environment. The system is also characterized by easy management.

When a very extensive world and a specific small community are compared, both the demand and value of a certain type of information are different in many cases. For example, when a group consisting of all the people of a certain country is compared with a group consisting of experts in a specified, information in the field of experts has a greater demand, so the value of expert information is higher. Further, the knowledge of experts is richer, so accurate value can be added information in that field. Among the group of experts, information of the specified field is not often buried among many types of information, so information value is found out earlier. This is a great advantage. Thus, further object of the present invention is to provide a system characterized in that a virtual space can be formed among a small group such as a group of experts and accurate representation of the value of information in the related field can be implemented by the use of virtual currency in this virtual space. Not only that, the system allows the information sender to get get the information worthy of the value via the virtual currency. In other words, it is intended to provide adequate value in conformity to the demand in various fields.

Another object of the present invention is to provide a processing system and recording medium for economic data in a virtual space which offer an opportunity of using for the benefits of the society the creativity of jobless persons and so-called part-timers who are making their living by irregular unspecified part time job.

Still another object of the present invention is to provide a processing system and recording medium for economic data in a virtual space which ensure an opportunity for any people to find employment without being restricted to a particular place and time, especially to a particular place.

Further object of the present invention is to provide a processing system and recording medium for economic data in a virtual space which realize economic activities ensuring safe value distribution.

Still further object of the present invention is to provide a processing system and recording medium for economic data in a virtual space which allow indirect reflection of economic activities on the Internet upon the real world.

Still further object of the present invention is to provide indirect economic data in a virtual space to ensure that transactions on the Internet free from illegal actions can be reflected upon the real world.

Still further object of the present invention is to provide a processing system and recording medium for economic data in a virtual space which remove miscellaneous low-valued information from various types of information provided on the Internet free of charge in principle, and offer truly valuable information in a valuable form, wherein the system contains paid form of services basically.

Still further object of the present invention is to provide a processing system and recording medium for economic data in a virtual space which allow anybody to create social value without involving consumption of energy for transportation of humans or goods.

Still further object of the present invention is to provide a processing system and recording medium for economic data in a virtual space which permit quick display of the results of economic activities in virtual space and and the balance of income and expenditure for each subject identified by the ID data in terms of virtual currency and or actual currency.

The above objects can be solved by the following embodiments:

1. An economical data processing system, including: a means to form a virtual space in use with a network which includes a plurality of computers connected to each other; a means to form virtual currency which indicates a value index in the virtual space; and a virtual currency storing a means to store the virtual currency; in which the virtual currency is delivered in the virtual space.

2. The economical data processing system of the above item 1, further including: a valuable information storing means to store valuable information representing value provided in the virtual space; in which the valuable information is delivered in the virtual space.

3. The economical data processing system of the above item 2, in which value of the valuable information is represented as value data, indicating the virtual currency, in the virtual space; and the valuable information storing means stores the valuable information in relation with the value data.

4. The economical data processing system of the above item 2, in which the valuable information is exchangeable with the virtual currency in the virtual space.

5. The economical data processing system of the above item 2, in which the valuable information is represented as value data, indicating the virtual currency, in the virtual space; further including: a valuable information evaluation means to evaluate a value of the valuable information so as to generate the value data of the valuable information.

6. The economical data processing system of the above item 2, further including: a ID data generating means to give ID data to a subject which delivers the virtual currency in the virtual space.

7. The economical data processing system of the above item 6, further including: a ID data judging means to judge whether or not the subject is allowed to make a connection with the virtual space in accordance with the ID data, and to give a permission to the subject to make a connection with the virtual space when the subject has the ID data with authenticity.

8. The economical data processing system of the above item 6, in which the ID data generating means gives the ID data to a subject which delivers the valuable information; and the valuable information storing means stores the valuable information in relation with the ID data.

9. The economical data processing system of the above item 6, in which the virtual currency storing means stores the virtual currency in relation with the ID data.

10. The economical data processing system of the above item 1, further including: a virtual currency evaluation means to evaluate the virtual currency in a value system of real currency.

11. The economical data processing system of the above item 10, further including: a means to exchange the virtual currency with the real currency in accordance with the evaluation result of the virtual currency evaluation means.

12. The economical data processing means of the above item 2, in which the valuable information is image information.

13. The economical data processing means of the above item 1, in which a subject is given the virtual currency as a reword for being restricted in the virtual space for a period of time.

14. An information processing apparatus, in use with an economical data processing system of a virtual space which is provided by a network of a plurality of computers connected to each other, including: a means to form virtual currency which indicates a value system in the virtual space; in which the virtual currency is delivered in the virtual space.

15. A recording media for recording a program of the economical data processing system of the above item 1.

Another embodiment is a processing system for economic data in a virtual space comprising;

(1) a means to form a virtual space,

(2) a means to store valuable information provided in a virtual space by a subject identified by ID data in the form of digital data, and

(3) a means to convert the digital data into the value in terms of currency,

wherein the processing system is further characterized in that the storage means stores at least the digital data associated with the subject identified by the ID data.

In this embodiment, the virtual space is located preferably in a memory (including virtual memory). It may be located in a server (virtual space server to be discussed later) or may be distributed in multiple servers or multiple terminals. Such a virtual space provides a place for activities based on offered value and activities based on reception (acquisition) of the value.

The virtual space in the present embodiment implements virtual economy by introduction of new currencies different from those of the real world and or new criteria of value. Thus, it permits exchange of the value different from that of the real world in the virtual space; for example, it allows economic activities.

Economy in the virtual space where market prices are quickly reflected maintains a balance between the services desired by consumers and those of service providers. Consumers have a growing opportunity of receiving the services at an adequate price based on the principle of competition. Conversely, transactions in the virtual space can give favorable influence to the formation of adequate transmission prices in the real world.

If economy in the virtual space is satisfactory, there is no need of consuming a huge amount of energy in achieving economic purposes. It prevents global warming or public pollution. Economic activities in virtual space reduces costs and creates a “paperless” community.

The subject identified by ID data to provide valuable information is defined as an entity capable of independent activities including an individual person or corporation.

According to the present embodiment, the value is provided, for example, in terms of various types of information by the supplier based on the balance of demand and supply. Such information includes image information data, required on-demand information data, and various types of program data. The subject providing value to the virtual space intends to perform the activities, and is not restricted to any particular person if he can operate a computer connected to the network. The system according to the present invention works favorable to the physically handicapped, the aged or other persons incapable of doing free activities, when such persons have intelligence and knowledge. Persons unable to take part in economic activities can offer value in the virtual space and can receive monetary value (currency). They can fine jobs in the virtual space and work therein even if they cannot find employment in real world. In this respect, the present system is particularly preferable. Thus, the system provides life worth living to the handicapped or aged people, awakes the latent power to create value and encourages them to take part in the social activities. It allows part timers and jobless people to spend their time to take part in the social activities and assists them to solve the current employment problem.

The valuable information provided in the virtual space contains digital data including time factor, for example, provided by the supplier based on the balance of demand and supply in economic activities in the virtual space. It is worthy of the compensation to be paid the value receiver (demand side). It includes all the information which produces the compensation, for example, in economic activities in the narrow sense of the word, educational activities, social activities, consultation, activities accompanies by time restrictions and the activities which produces the compensation in the employment based on contract in the virtual space.

The value provided in the virtual space is converted into digital form. Such information is preferred to be converted into the digital information protected by cryptography to prevent illegal acquisition of such information.

The digital information is preferred to be the valuable information which can be divided into a specific unit. This is intended to permit partial transaction, and to facilitate when it is very high-priced and when it is to be sold in the form of many small pieces of information.

“Currency value” in the sense of the present embodiment can be classified as currency value valid in the virtual space, the one valid in real world or the one valid in both. The preferred one in the present invention is the currency value valid in the virtual space.

Currency value valid in the virtual space is found in the digital virtual currency (hereinafter referred to as mere “virtual currency” in some cases). For example, “100 E credit” (equivalent to 10 yen) can be cited as a specific creative unit, without being restricted thereto. The one valid in real world includes such digital currency value as yen, collar, euro (hereinafter referred to as “electric money” in some cases), without being restricted thereto. It is preferred to be a virtual currency having digital value endorsed by yen, etc. Since it is not a direct real currency, it is possible to prevent crime or fraudulent action in virtual space before actual damages occur. It allows preventive verification.

Electronic money and virtual currency are preferred to be usable in certain units without being modifiable.

Virtual space is desired to be a community where virtual currency is introduced to conduct economic activities. To achieve this purpose, value is provided and compensation for the received value is produced in virtual space. The digital virtual currency is used for the payment of the compensation. It is possible to accumulate compensation through activities in virtual space and to store properties. Further, the stored properties can used to purchase other values.

The properties stored in virtual space need not necessarily be valid in the real world. They are preferred to be convertible with the real world currency value. For example, it is preferred to have a conversion means to allow exchange between virtual currency (e.g. “100 E credit”) and real currency (yen, dollar, etc.).

The conversion means can be implemented by a bank server, by a bank established in virtual space (virtual bank) or by a real world bank. Further, conversion may be made by a manager in virtual space (for example, virtual space server manager). A commission may be collected for conversion. In order to make the virtual community active, it is preferred that conversion can be made at the market and convenience store.

When virtual economy is activated and the demands are increased, the value of the virtual currency will increase, market prices will be formed with the real world currency according to the present invention, and the virtual currency itself will come to be associated with the real world economy value. An exchange agency on the network is preferred for formation of market prices.

When the value resulting from activities in virtual space is converted into currency according to the present embodiment, it is desired to carry out preliminary assessment actions required for conversion into currency value such as evaluation, determination and declaration of the compensation as digital symbol.

To carry out the preliminary evaluation, it is possible to appoint an agency to determine compensation or a site to declare the amount of compensation on the virtual space (e.g. on web pages). If the amount of compensation is made public, access to the system and purchase of goods will be made more reliable. When the amount of compensation is determined, it is preferable for system improvement integrity to be set lower than the value according to the real world value criteria.

When the price for digital valuable information is displayed on the Internet according to the present invention, greater safety in the transaction of the value will be ensured if a consultant or quality assurance agency is available regarding the valuable information.

Further, it is preferred to declare actual real world prices in parallel to digital currency price.

In the present embodiment, a “storage means to store as a digital data the valuable information provided in virtual space by a subject identified by ID data” may be installed in the database of the virtual space server or in the database of the exchange server which permits exchange of data with the virtual space server. Or the storage means may be installed separately in the terminal memories of such servers as virtual space server and exchange server. It is preferred that the storage means be installed in a position enclosed by Firewall such as proxy server.

In the present embodiment, “storage of digital data in association with the subject identified by the ID data” is intended to ensure that a value provider can provide the information in an easy and carefree manner if valuable information as digital data is associated with the value provider identified in the storage of valuable information. Digital valuable information is preferred to be stored when it is associated with ID information through the server protected by such a security protective means as Firewall. In this case, delivery of the value is preferably enabled by replacing the ID information.

Another embodiment is a processing system for economic data in a virtual space comprising;

(1) a means to form a virtual space,

(2) a means to store valuable information provided in a virtual space by a subject identified by ID data in the form of digital data, and

(3) a means to to convert the digital data into the value in terms of currency,

wherein the processing system is further characterized in that the storage means stores at least the digital data associated with the subject identified by the ID data, and the currency value produced in the virtual space.

In other words, the present embodiment is characterized by storage of not only the digital value but also currency value produced in virtual space. If the amount stored data has increased by successive storage of economic data in virtual space, there will be an increase in the willingness to store value. This will promote economic activities in virtual space.

The preferred characteristic in the above embodiments is that the system has a means to store the converted currency value. When the value provided in the virtual space is converted into the currency value, the system is preferred to have a recording means, regardless of whether the currency value is valid in the virtual space or valid in the real world. For example, the value can be recorded into the electronic card from the data stored in the database of the virtual space server or the like.

In the above embodiments, it is preferred that there be an agency which guarantees the payment of the currency equivalent to the value of the stored digital data. Namely, it is preferred that there be an agency which guarantees the payment of the currency equivalent to the stored actual value. The guarantee agency can be the bank (bank server), or a new guarantee agency can be established. The guarantee system may be financed by, for example, the membership costs of system participants or by subsidy. It can also be financed by the company managing the system according to the present invention.

The digital currency represents private value, and careful measures must be taken to avoid the risk which may be assumed by the user. To ensure safety against possible damages, it will be effective to set up a ceiling on usage, to establish a insurance system or set up a validity period.

According to the present embodiment, a false E credit is necessary in some cases. For example, if there is no specific signal after the lapse of a certain period, automatic deletion function can be used. In this case, the signal is sent automatically from the server after the lapse of a certain time. The signal is desired not to be sent if a suspension signal has reached the server from a digital personality before it is sent.

Another embodiment is a processing system for economic data in a virtual space comprising;

(1) a terminal server by which the subject who provide value in virtual space is connected with the Internet,

(2) a virtual space server to establish a virtual space, and

(3) an exchange server to record and store the data exchange in the virtual space related to valuable information input from the Internet;

the processing system further characterized in that the exchange server records and stores the valuable information converted into the currency value which is virtually associated with the valuable information as an economic data.

The preferred characteristics of the processing system are that (1) the virtual space can communicate with the ID data server which authorizes the subject identified by ID data to be connected with the processing system for economic data in in virtual space, (2) the valuable information associated with the subjected identified by the ID data is stored in the exchange server, and (3) a server to convert the valuable information into currency value is provided separately from the exchange server. Specific description will be given later.

The embodiment is desired to have a bank server which converts the currency value into currency value valid in virtual space or into the currency value valid in the real world community. It goes without saying that only the virtual space server can be used without any bank server.

In the embodiment, the rate where the currency value is converted into the one valid in the real world community can be either fixed or variable. When it is a fixed rate, the activity of virtual economy can be controlled by increasing or decreasing the value based on real world economy with respect to the value provided in the virtual space. Further, in the case of the variable rate, it is preferred that the rate be automatically changed based on the economic indicator of at least one of the economy in virtual space and economy in real world (some factor for each). For example, if the demand in the real world economy is greater than that in the virtual economy, the price can be increased accordingly. It is desired that decision is made according to demand and supply in the exchange of each actual currency.

It is preferred in the embodiment that the currency value valid in the real world community be changed without being predicted at least in the virtual space. Namely, in the present embodiment, the value provided in virtual space may be converted into the real world currency value. In such cases,

it is desired that the change is made without being predicted at least in the virtual space, because it is not very convincing to the people using the virtual space. Virtual economy depends on reliability and guarantee. To ensure this, severe security protecting agency and system are essential.

For example, automatic change of the currency value according to the economic indicator of virtual space without prediction is also preferred if understanding of the users can be obtained.

In the embodiment, the business of valuable information provided in virtual space can be classified as the one accompanied by movement of products and the one without it. The business without movement of products includes advertisement and publicity of products and services, instructions for examinees at preparatory school, recruitment of private tutors, founding and operation of companies, call for photos exhibited at photo studios, establishment of laboratories, sales advertisement and guidance of right of intangible properties, call for labor forces, offer of labor forces, screening of movies of one's own making, rental libraries of paperless books, educational institutions and various media. Although there is allowance of time in achieving the objects according to the present invention, it is desired to access the pace to show the time available for working and to provide labor and services. Depending on individual employment contracts, it is possible to work irregularly only for the time available. Data on such labor and service are stored. Business accompanied by movement of products includes sales of various pieces of software and software of one's own making, sales of various securities and bonds, sales of various video tapes and sales of land or residence. For effective embodiment of the present invention, business without movement of products is desired.

In the embodiment, at least one of economic activities in virtual space is preferred to be related to image. Business related to image in the above lists includes exhibition of photo images in a photo studio, establishment of a laboratory, screening of movies of one's own making, offer of various media, production of various pieces of software, production of various video tapes and exchange of photographs and creative images.

It is preferred that at least one of the following economic activities can be made based on the compensation acquired in virtual space as an extension of digital data; 1) use as monetary data when receiving services in the virtual space, 2) borrowing and lending and 3) investment and 4) deposit.

Use as monetary data when receiving services in the virtual space allows physically handicapped persons to work in virtual space. If they deposit the compensation received, and convert it into the real world currency, they can use it in the real world society, and can get paid nursing care, for example. The balance of income and expenditure are recorded in the database of the virtual space server or the like. If the compensation received can be lent or borrowed, the property value will be increased. Further, the property will be further increased by investments of digital data obtained from the work in virtual space, and this is further to be preferred. If deposit can be made, it is possible to make a fortune.

In the embodiment, when economic activities in virtual economy is converted into those of real world economy and are realized as material substances, it is preferred that a means be provided to make a choice between payment by means of digital data and transaction endorsed by real world currency in order to dispose of real world costs having occurred. When economic activities in virtual economy are converted into those in substantial economy

and are realized as an image recording medium, it is desired that a means is provided to make a choice between payment by means of digital data and transaction endorsed by real world currency in order to dispose of real world costs having occurred. It is desired to shift to the implementation process to enter real world economy after electronic verification of solvency. In other words, when economic activities in virtual economy are converted into those in substantial economy and are realized as a material substance (e.g. image recording medium showing beautiful nature, a huge expansion of ocean, whales and beautiful human postures) in the embodiment, it is preferred for system users that a means be provided to make a choice between payment by means of digital data and transaction endorsed by real world currency in order to dispose of real world costs having occurred.

In the embodiment, protection of the anonymity of the persons accessing the virtual space is desired in increasing the number of good system users. To ensure such anonymity conditions, an anonymous server can be used. Use of a proxy (firewall) or multi-stage proxy server is also possible.

Another embodiment is a processing system for economic data in a virtual space characterized in that a virtual space server forming the virtual space is accessed through the Internet, and currency value is provided to the person on whom restrictions of time are imposed as a compensation for the restrictions, wherein the transaction data is stored in the server. This is intended to convert spare time into value. For example, spare time can be used to keep watch of a virtual shop.

Another embodiment is a processing system for economic data in a virtual space characterized in that a virtual space server forming the virtual space is accessed through the Internet, and employment is found in the space, wherein currency value is obtained in terms of digital data as a result. Preferred characteristics are as follows: 1) The currency value is the one valid in the virtual space. 2) The currency value can be exchanged with that valid in the real world community. 3) An agency is established to guarantee payment of the currency value. 4) The rate at which the currency value is converted into the real world currency value depends on the going market rate between currency value valid in the virtual space and the real world currency value.

The embodiment is desired to be implemented by the virtual space in terms of at least one of the universe, start, town, city, ward, village, and undeveloped area on the beach, plateau and others.

The virtual space is preferred to expand into two or more pieces of virtual space. In this case, it is preferred to determine association between currency values in two or more pieces of virtual space. For example, economic activities in one piece of virtual space are normally independent of those in another, so demands are different from each other.

In this case, currency value gained by activities in the virtual space with greater demand is higher, and these different currency values form different market prices. This is preferable. Such market prices themselves are accompanied by economic effects, and an effective system can be created by competition between different types of virtual space, and this is preferable.

In the embodiment, implementation of a virtual space in terms of community is also desirable.

In the present Specification, “community” can be defined as a set of subjects to provide value or to perform activities to meet the demands for value according to the present embodiment.

For example, a ward, town or village consists of a community comprising a set of a shop, employee leasing company (including the dispatch of tutors), life consultant office, photo studio, parking site, vacant lot, hotel, health consultant office, scenario school, hobby site, artist circle, golf center, bar, virtual educational institution, virtual public government office, and others.

A health insurance society or friendly benefit society in a company and organization is a community preferred in the present invention. The current health insurance society has to deal with increasing treatment of the aged people, and are put into financial difficulties. Such a society can form a virtual space according to the present invention to make an effective use of the persons having retired from the company, thereby filing financial deficiency. Retired people have a high level of knowhow, skill and knowledge, and such advantages can be used to exchange value in the virtual space according to the present invention, and profits can be obtained. Part of such profits can be used meet the financial requirements of the society.

When those qualified by state examination or others and engaged in business in the real world community are to do business in virtual space, it is preferred that the qualification be made valid in virtual space as well, and such qualification be officially verified.

Another embodiment is a recording medium loaded with the program of the processing system for economic data in a virtual space. The recording medium includes a floppy disk, CD-R, MO, CD-ROM, PD, DVD-RAM, DAD-ROM, DVD-R and semiconductor chip.

### BREAF DESCRIPTION OF THE DRAWINGS

FIG. 1 is a drawing representing the processing system for economic data in virtual space according to the present invention;

FIG. 2 is a drawing representing the communications between virtual space server and ID data server;

FIG. 3 is a drawing representing the communications between virtual space server and exchange server;

FIG. 4 is a drawing representing the details of the exchanger server database;

FIG. 5 is a drawing representing the details of the exchanger server database;

FIG. 6 is a flow chart representing an example of the system when the subject accesses the Internet;

FIG. 7 is a flow chart representing an example of the system when the subject enters the virtual space;

FIG. 8 is a flow chart representing an example of the system when the value is provided;

FIG. 9 is a flow chart representing an example of the system when a desired service or valuable information provided in the virtual space is received;

FIG. 10 is a flow chart representing an example of the processing system when the subject having entered a virtual space finds employment in a shop (company) in virtual space as one of his activities in the virtual space;

FIG. 11 is a flow chart representing an example of the processing system to keep watch of a virtual shop.

FIG. 12 is a flow chart representing an example of the processing system for conversion of virtual currency into yen;

FIG. 13 is a flow chart representing an example of the processing system to determine the exchange rate for conversion of virtual currency into yen;

FIG. 14 is a flow chart representing an example of the processing system to change the exchange rate for conversion of virtual currency into yen; virtual space

FIG. 15 is a flow chart representing an example of the processing system to determine the self-image in virtual space;

FIGS. 16(A)-16(C) are drawings representing the image of web pages;

FIGS. 17(A) and 17(B) are drawings representing the image of web pages;

FIG. 18 is a flow chart representing the software to run images on web page;

FIG. 19 is a drawing representing an image of web page; and

FIG. 20 is a drawing representing an image of web page.

### DETAILED DESCRIPTION OF THE INVENTION

A processing system for economic data in a virtual space according to the present invention comprises 1) a means to form a virtual space using the network connected with multiple computers, 2) a means to form a virtual currency serving as an indicator for value in virtual space, and 3) a virtual currency storage means to store the virtual currency. Virtual currency is exchanged among multiple subjects in virtual space.

All the means according to the present invention (not restricted to the above-mentioned ones: means to be discussed in the following description are also included) can be contained in one apparatus. Or they can be separate apparatuses respectively. Or some means may be incorporated in one apparatus, with the rest built in another. Or one means may consist of multiple other apparatuses. Or one and the same apparatus or device may serve as multiple means.

Further, the Internet is typical of the network linked with multiple computers. The means of forming virtual space may be a server (for example, a virtual space server to be discussed later) or computer. Virtual space may be formed by multiple servers or computers or by the network including the Internet. The following shows a preferable virtual space to describe the concept thereof: For example, when entering the virtual space (preferably, and quitting it as well), there is a port to check eligibility and suitability for entering the virtual space as well as ID information. After entering the virtual space through the port, virtual currency and valuable information according to the present invention are exchanged among multiple subjects through network in that virtual space. Further, deposit (storage) of virtual currency and storage of valuable information are also possible in the virtual space.

Virtual currency is an indicator to represent the value valid in the virtual space. It is an electronic virtual currency. (It is different from “electronic money” wherein currency in real world is exchanged as digital data). Virtual currency is preferred to be digital data. To be an indicator and to be exchanged, virtual currency is desired to be represented in terms of numerals. Further, to distinguish it from the real world currency, it is preferred to have a unique unit of its own. For example, it can be represented as 100 E credit or 1,000 E gold. In virtual space, virtual currency serves as an indicator for value, so it is preferred to allow economic activities to be conducted, similarly to the real world currency. It is also desirable that virtual currency can be exchanged among multiple subjects in virtual space. In this case, it is desired to be exchanged as digital data through the network. Examples of desired functions of virtual currency can be extended to include deposit, loan, donation, and exchange between virtual currency and something of value, which includes those objects which require physical movement in the real world. Preferred are those that can be exchanged in the virtual space. Valuable information as digital data is a good example.

Requirement for virtual currency is validity in the virtual space. Virtual currency may not be usable in the real world. However, it is preferred that there be an exchange rate between virtual currency and real world currency so that they can be exchanged. In this case, the system is desired to have a means for exchange between virtual currency and real world currency. Such a means may be a server (e.g. bank server to be discussed later) or computer. Or it may be formed by multiple servers or computers.

It is desirable that exchange of virtual currency is carried out through the network.

The means of forming virtual currency may be a server (for example, an exchange server to be discussed later) or computer. Virtual currency may be formed by multiple servers and computers. Virtual currency is formed as digital data. The means of forming virtual currency may be so designed that a new virtual currency is created in response to the command of the manager in virtual space, for example. Or it can be so designed that the amount of virtual currency used in virtual space is detected, and the amount of a new virtual currency to be created is determined based on the result of detection, thereby allowing virtual currency to be created automatically.

Further, the means of storing the virtual currency may be the one which plays the role of a real world bank, or the one serving as a purse of individuals in the real world. The means of storing the virtual currency may a server (for example, an exchange server to be discussed later) and computer. It may be formed by multiple servers and computers wherein, for example, the purse is divided into two portions to store the virtual currency separately; one for the bank and the other for an individual. To go into further details of the storage means, the following can be listed as specific examples; various memories, RAMs (DRAM, SDRAM, flash memory, etc.) and hard disks in the server or computer, various information recording media (FD, MD, MO, CD, CD-R, CD-RW, DVD, DVD-RAM, DVD-RW, MT, DAT, Zip, etc.) and record reader thereof. The storage means, however, is not restricted to them.

The economic data processing system is preferred to have a valuable information storage means which stores valuable information as information containing value provided in virtual space. Valuable information is desired to be exchanged in virtual space.

Valuable information is defined as information having some value for a subject in virtual space. Preferably, it is information which can be exchanged with virtual currency. In virtual space, it is desired that the value of valuable information is expressed as the value data with virtual currency as an indicator. For example, a photo A as a digital image can be expressed as valuable information worth 500 E credit in virtual currency. Valuable information includes image information, document information, program data and many others, and is desired to be digital data. Image information is also to be preferred.

In virtual space, valuable information and virtual currency are exchangeable with each other. Exchange between valuable information and virtual currency is desired to be conducted via through network. Valuable information and virtual currency are desired to be exchanged at an adequate virtual currency in conformity to the value of valuable information.

The storage means storing the valuable information can have the function of managing the valuable information in virtual space. It can serve as a database for individuals in the real world. The storage means storing the valuable information may be a server (e.g. bank server to be discussed later) and computer. Or it may be formed by multiple servers and computers wherein, for example, the database is divided into two portions to store the valuable information; one for the manager and the other for individuals. To go into further details of the storage means, the following can be listed as specific examples; various memories, RAMs (DRAM, SDRAM, flash memory, etc.) and hard disks in the server and computer, various information recording media (FD, MD, MO, CD, CD-R, CD-RW, DVD, DVD-RAM, DVD-RW, MT, DAT, Zip, etc.) and record readers thereof. The storage means, however, is not restricted to them.

The valuable information storage means is preferred to associate valuable information with value data expressed in virtual currency as a value thereof, and to store them. For example, image information B is offered into virtual space by a subject in virtual space. In the virtual space, a virtual shop specialized in handling image information automatically assigns the value data expressed in virtual currency (e.g. 600 E credit) or the value data based on evaluation of the value of the image information by the manager of the virtual shop.

Image information B together with the assigned data is stored in the storage means of the virtual shop in virtual space. Such examples can be cited.

Valuable information is desired to be offered by a subject in virtual space through the computer of the subject. The manager of the virtual space may offer valuable information through a means of creating virtual space or other computers. The same way of setting of the value in the real world is preferred to be applied to valuable information expressed in virtual currency. For example, the subject providing valuable information may set the value data. The manager of the virtual space may set the value data. A subject desiring to have the valuable information may set it. Or multiple subjects desiring to have the valuable information may set it by an auction or by consultation among them. It is also possible that a valuable information evaluating means to evaluate the value of valuable information automatically is provided in virtual space, and the value of valuable information is automatically evaluated by the means, thereby setting the value data expressed in virtual currency. The valuable information evaluating means may be a server or computer. Or it may be formed by multiple servers or computers.

The virtual currency storage means and valuable information storage means may be one piece of equipment or two different pieces. The virtual currency storage means and valuable information storage means may be composed of multiple servers and computers.

The economic data processing system is desired to have an ID data assigning means to assign ID data to the subjects exchanging the virtual currency in virtual space. The ID data assigning means may be a server or computer. Or it may be formed by multiple servers or computers. The ID data assigning means provides data to identify a subject in virtual space. The subject may be a natural human or body corporate. The means is desired to be used for management of each subject entering and quitting the virtual space and the activities therein. Preferred ID data is a combination of multiple characters and numerals, but is not restricted thereto. It is also possible to use a combination of password and ID data handled as secret information.

The economic data processing system is preferred to have an ID data evaluating means which evaluates the ID data to determine whether or not the subject can be connected to the virtual space. It is also desired that the ID data evaluating means determines that the subject having adequate data can be connected to the virtual space, and the subject without it cannot be connected to the virtual space.

It is also possible to make sure that the ID data assigning means assigns an ID data to the subject exchanging valuable information, and valuable information storage means stores the valuable information associated with ID data. It is effective, for example, to ensure that the ID data of the subject having issued valuable information is linked with valuable information, and is stored in that state. The ID data of multiple subjects can be linked with valuable information. For example, it is possible to ensure that the ID of the first subject having issued the valuable information is always associated with the valuable information, and, furthermore, the ID of the last subject having received the valuable information is associated with it.

The virtual currency storage means may store virtual currency and ID data associated with each other. For example, the valuable information may be linked with the ID data of the subject having paid the virtual currency. The ID data of the subject having received the virtual currency may be linked for storage. The ID data of multiple subjects may be linked with the virtual currency. The history of the subject up to now (only recent history) may be related to the virtual currency.

When an exchange rate between virtual currency and real world currency is present without the virtual currency being a value indicator valid only in the virtual space, and exchange between the virtual currency and real world currency is possible, then the economic data processing system is preferred to have a virtual currency evaluating means to evaluate the virtual currency in terms of the value represented in real world currency. The virtual currency evaluating means may be a server or computer. Or it may be formed by multiple servers or computers. Further, the economic data processing system is desired to have a means of exchanging between the virtual currency and real world currency based on the value evaluated by the virtual currency evaluating means. This exchange means may be a server or computer. Or it may be formed by multiple servers or computers. The real world currency exchanged with virtual currency may be electronic money or may be transferred into a real world bank account of the subject.

It is also possible to ensure that virtual currency can be obtained in the virtual space by the method other than that where the subject offers the valuable information. Means can be taken to make sure that virtual currency can be obtained by payment of real world currency through a means of exchanging between real world currency and virtual currency. It is also effective to ensure that the subject gets the virtual currency in compensation for his time being restricted in the virtual space.

The economic data processing system is desired to have a valuable information input means and a means to input valuable information and various instructions on virtual currency (payment, receipt, deposit, subtraction, lending, borrowing, donation, valuable information storage, valuable information donation, etc.). The input means may be a server or computer. Or it may be formed by multiple servers or computers. Such information can be entered by means of a button, keyboard, screen, vocal instruction. To go into further details,

the keyboard, touch panel, microphone, scanner or digital camera connected to the computer or server is desired to be used for this purpose. The economic data processing system is desired to have a valuable information output means and a means to output valuable information and various instructions on virtual currency. The output means may be a server or computer. Or it may be formed by multiple servers or computers. Such information can be output by screen display, printing, vocal output or the like. To go into further details, various displays (CRT display, liquid crystal display, display plasma, organic EL, etc.), various types of printers and speakers connected to the computer or server is desired to be used for this purpose.

The program of the economic data processing system according to the present invention is desired to be recorded on a recording medium. The recording medium includes various memories, RAMs ((DRAM, SDRAM, flash memory, etc.) and hard disks in the server or computer, and removable various information recording media (FD, MD, MO, CD, CD-R, CD-RW, DVD, DVD-RAM, DVD-RW, MT, DAT, Zip, etc.). The recording medium, however, is not restricted to them.

The following describes the embodiments of the present invention with reference to drawings:

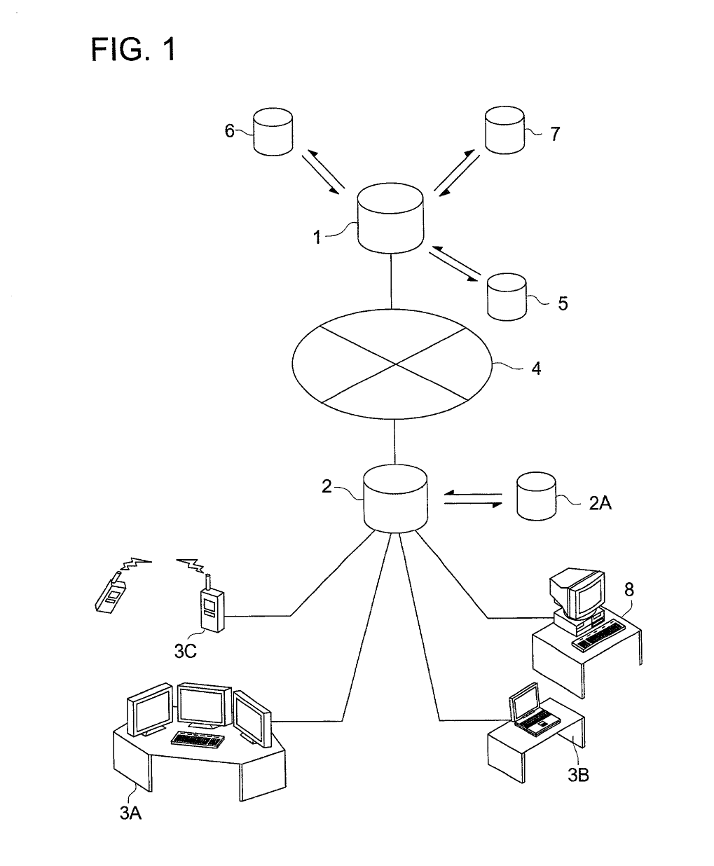

FIG. 1 shows one embodiment of the economic data processing system in a virtual space according to the present invention. In this drawing, numeral 1 denotes a virtual space server to create virtual space. It is a main server to manage the system according to the present invention.

Numeral 2 denotes a terminal server used to connection between the Internet 4 and terminals 3A, 3B and 3C managed by the subject providing value in virtual space and terminal 8 managed by the subject receiving value. 2A indicates an authentication server to determine if access is authorized or not. Numeral 5 shows the ID data server which stores the data determining if access to the system according to the present invention is authorized or not. Decision according to ID data server 5 is made based on the personality information of the ID or the like stored in the database of the server.

Numeral 6 denotes an exchange server to record and store the data exchange in the virtual space related to the valuable information input from the Internet 4. Use of such an exchange server allows the valuable information to be recorded and stored in the exchange server in association with the subject identified by the ID data.

Valuable information must be converted into the currency value. The present invention is desired to have a server which converts the valuable information into currency value.

Numeral 7 indicates a bank server by which currency value converted in the manner is converted into currency value valid in virtual space or into the currency value valid in real world community. A database may be built in the server or a separate database may be provided.

A means to access the virtual space is available in the following three forms without being restricted thereto; a form of using a terminal 3A equipped with a three-face liquid crystal display as illustrated, a form of using a PC terminal 33, and a form of using cellular phone terminal 3C. The cellular phone is not restricted to the normal one (e.g. “i-mode” by DOCOMO); PHS and other means of communication may be used.

To enter the virtual space, access is made through the Internet. In order to encourage participation in the virtual space, it is desired that access expenses are free or are set at a low price at the start.

To facilitate access for those desiring to start economic activities in virtual space, it is desired, for example, that a specified amount of subsidy (e.g. 250 E credit) is granted to those having their ID data registered in virtual space.

If an access assist function to increase the amount of electronic money is added in conformity to access time when access is made to the virtual space, for example, to view commercials and advertisements, then participation in the virtual space will be encouraged. The reason for increase of the amount of electronic money is that access time is regarded as labor time. Accordingly, if activities in virtual space are stopped for a specified time or more, increase in the amount of electronic money is desired to be stopped. The electronic money obtained can be used to get services in the space. In this case, compensation equivalent to the work time can be determined based on the earnings obtained by the advertisement for the real world community provided in virtual space.

Further, if the value in the virtual community is set at a lower value, it will be easier to enter the system according to the present invention. Those who has come only to browse through the virtual space will perform economic activities to get profits in the virtual space. When logging off the virtual space, such profits may be recorded in the space or deposited in the bank account before logging off. When logging on the system the next time, they can get the electronic data which has been stored as their possession, and can start economic activities in the virtual space. Such a method is also preferable.

In the system according to the present invention, it is desirable to purchase virtual currency (E credit) with real world money since it increases the number of participants in the system.

Numeral 8 denotes the terminal managed by the subject receiving value in virtual space. It can be accessed in the same manner as the one managed by the subject providing the value.

In the form shown in FIG. 1, the terminal server, exchange server and bank server functions can be performed only by a virtual space server. When system maintenance is taken into account, it is more desirable to have servers for each function. When all functions are to be performed by only the virtual space server, installation of multiple serves is preferred.

If terminals 3A, 3B and 3C managed by the subject providing value and terminal 8 managed by the subject receiving value in virtual space are correctly managed, there is no problem with them. Even if terminals are not owned by the subject, it is sufficient that password or the like can be managed by him.

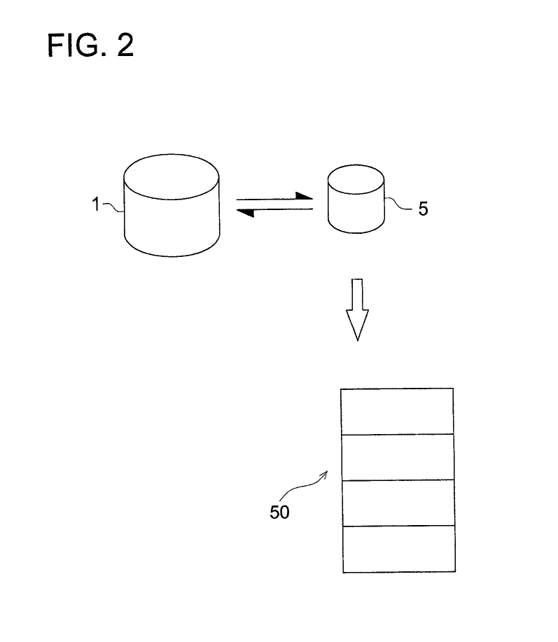

FIG. 2 shows communication between the virtual space server and ID data server. In FIG. 2, a virtual space server 1 functions as a web server, and ID data server 5 functions as a database server. Numeral 50 indicates a database.

The database 50 stores the ID, password, name, date of birth, account number, telephone number and other information identifying a person (e.g. license number, insurance certificate number) in digital form. The column for personal information in digital form is important in the sense that the system itself guarantees those performing economic activities in virtual space

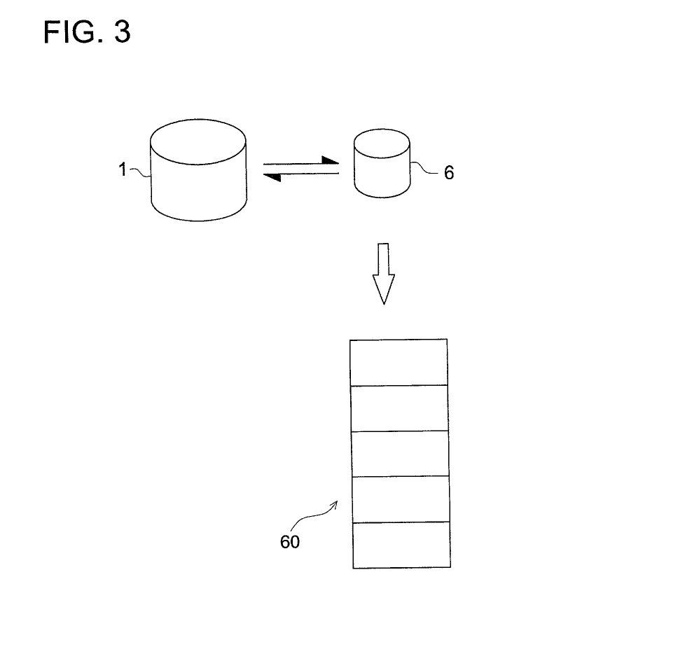

FIG. 3 shows communication between the virtual space server and exchange server. In FIG. 3, a virtual space server 1 functions as a web server, and exchange server 6 functions as a database server. Numeral 60 indicates a database.

Database 60 stores the provided valuable information in the form of digital data. At the time of registration and storage, a registration number is desired to be assigned. Further, it is also preferred that valuable information be classified for each theme, and registration number be assigned for each classification. Valuable information may be classified with reference to the Japanese Standard Industrial Classification issued by the Japanese administration agency (e.g. major classification A: agriculture, major classification B: forestry, . . . , major classification F: manufacturing, etc.). Or it can be classified according to a unique classification standards (e.g. major classification: product/service, Intermediate classification: individual transaction/transaction on company basis).

Database 60 stores the history data on the activities of the value provider and value receiver in virtual space which is associated with ID.

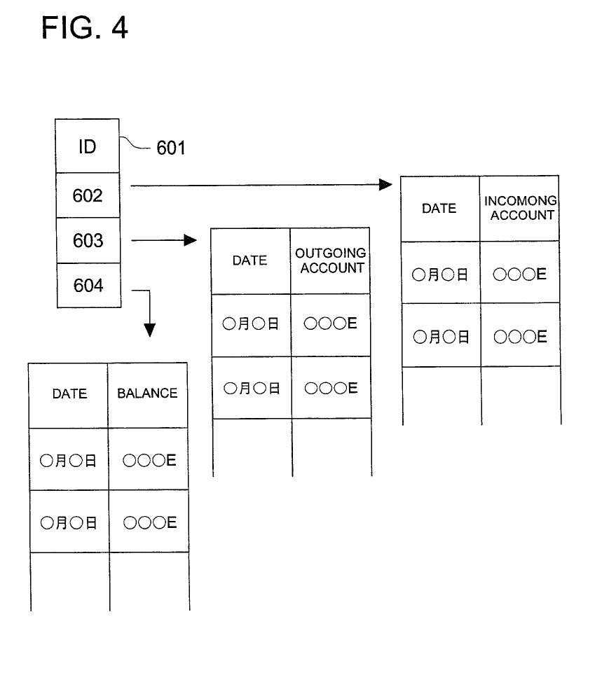

The database 60 recording and storing the history data on the activities and accounts of the value provider contains four columns; ID column 601, incoming account column 602, outgoing account column 603 and balance column 604, as shown in FIG. 4. Each column is divided into a date column and amount column. The data is stored as digital data.

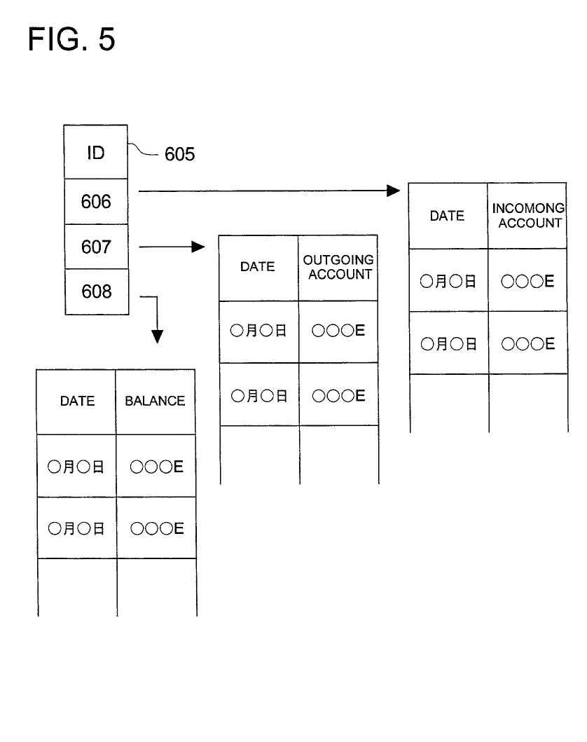

The database 60 recording and storing the history data on the activities and accounts of the value receiver contains four columns; ID column 605, incoming account column 606, outgoing account column 607 and balance column 608, as shown in FIG. 5. Each column is divided into a date column and amount column. The data is stored as digital data.

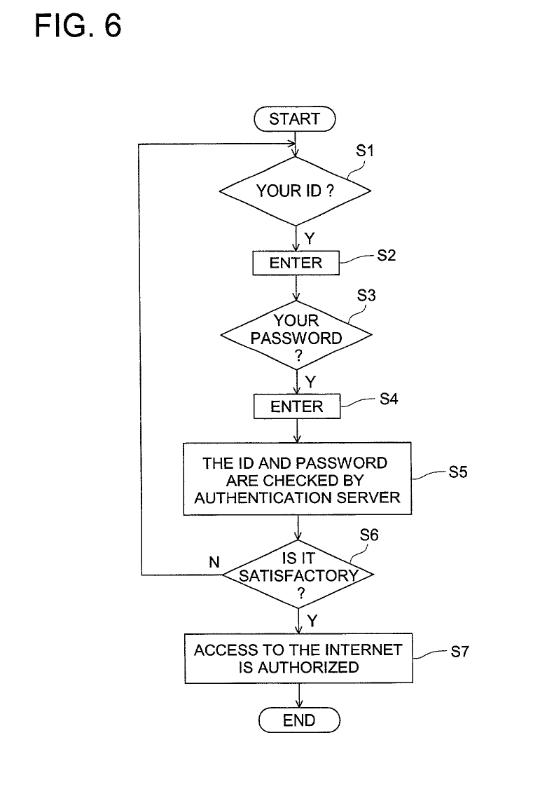

The following describes an example of the processing system for economic data in in virtual space according to the present invention with reference to the flow charts shown in FIGS. 6 to 15.

FIG. 6 is a flow chart representing an example of the system until it is connected to the Internet by the subject through a terminal server 2 (see FIG. 1, same for the rest). Firstly, terminal server 2 asks a question regarding connection ID (S1) In response, the subject enters the specified connection ID (S2). The terminal power 2 asks a question on password (S3). In response, the subject enters the specified password (S4). Then terminal server 2 compares these IDs and passwords for access with those stored in the database located in the authentication server 2A (S5), and verifies them (S6). If they are correct, access to the Internet is authorized (S7), and the subject is permitted to access the Internet.

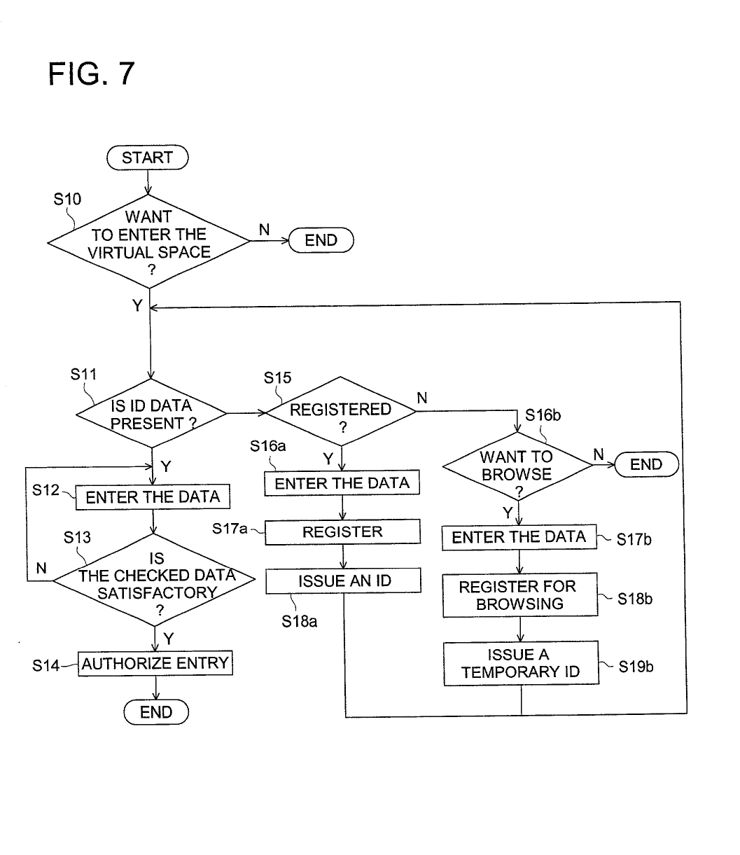

FIG. 7 is a flow chart showing an example of the system when the subject enters the virtual space. Firstly, a virtual space server 1 (See FIG. 1, same for the rest) asks the subject having accessed this system to verify if he wants to enter the virtual space (S10). Then the system verifies the presence or absence of the ID data for the subject desiring to enter the virtual space (S11). This ID is a system ID different from the access ID. The subject having ID data enters the ID data (S12). Then virtual space server 1 exchanges data with ID data server 5, which stores the database, to check such input ID data (S13). Thus, entry into the virtual space is authorized by the virtual space server. Then verification is made to check the type of activities in the virtual space, namely, to see if value is provided or received (S14). In the meantime, the subject without ID data is asked by virtual space server 1 to verify if he want to have the ID registered or not (S15). When ID is to be registered, ID information registration data is entered by the subject (S16a). The ID information entered by the ID data server 5 is registered (S17a), and ID data is issued (S18a). Further, when the ID is not registered in S15, the subject is asked if he want to browse or not (S16b). If so, the subject enters the data for registration of browsing (S17b). The browsing registration data entered by the ID data server 5 is registered (S18b) and temporary ID data is issued (S19b). The subject of ID returns to the ID data verification flow in S2 through the issued ID or temporary ID. Through this step, entry to the virtual space is authorized.

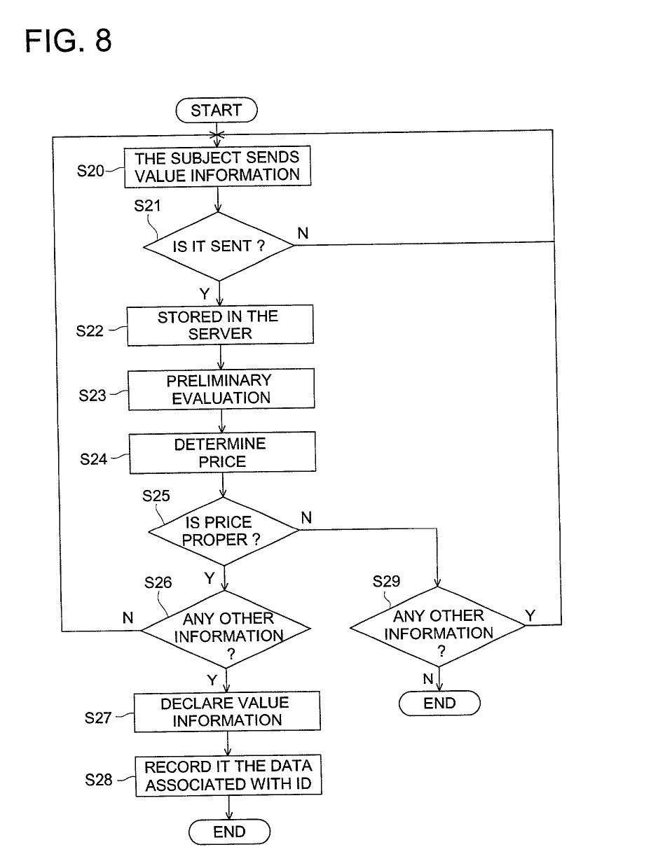

FIG. 8 is a flow chart representing an example of the system when value is provided as a result of the subject having selected provision of value. Firstly, the virtual space server 1 requests transmission of the valuable information to be provided (S20). When the value provider has sent the information on its own digital value, the space server 1 verifies the transmission (S21). Then the valuable information is stored in the exchange server 6 (S22).

Then the stored valuable information is subjected to preliminary evaluation when preliminary evaluation software has started (S23). Thus, the valuable information sent by the value provider is evaluated, and price in virtual space is determined (S24). The price determined by preliminary evaluation is checked with the value provider by virtual space server 1 (S25). If it is approved, verification is made to check if there is any other valuable information to be provided (S26). If there is any other valuable information to be provided, the system goes back to S20 to receive valuable information. If there is no more valuable information to be provided, valuable information from the value provider provided in the exchange server 6 is declared in the virtual space by virtual space server 1 (S27). These activities are associated with the ID and are stored in the exchange server 6 (S28). The whole process is now complete.

If the price determined in preliminary evaluation is not approved by the value, virtual space server 1 verifies to check if there is any other valuable information to be provided (S29). If there is any, the system goes back to S20, and receives valuable information again. If there is no more valuable information to be provided, the whole process is now complete.

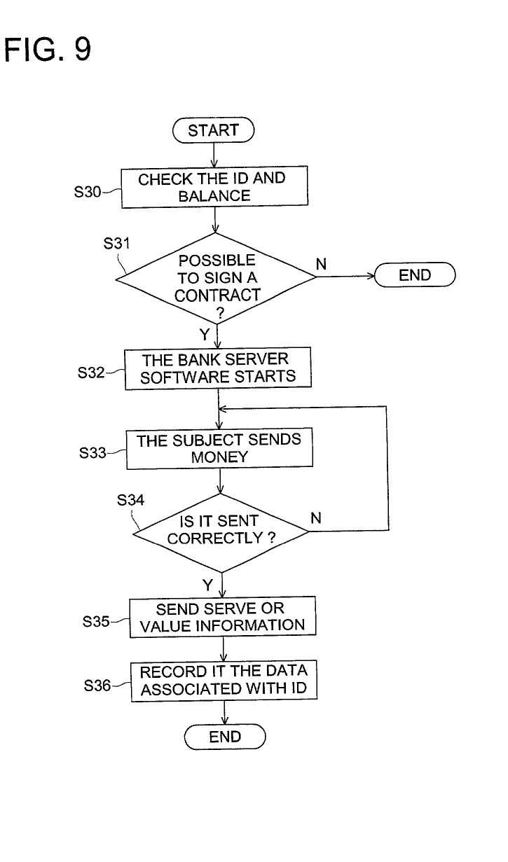

FIG. 9 is a flow chart representing one example of the processing system wherein the subject having entered the virtual space receives a desired service or valuable information provided in virtual space in an activity in virtual space.

Prior to receiving a desired service or valuable information, ID data of the subject and the balance of virtual currency or real world currency associated with the ID data are checked (S30). Then based on the result of the check, the system determines if the subject is qualified to receive the information or not, and if a sales contract can be signed between the subject and value provider (S31) or not. If the contract can be be signed, the bank server software starts (S32).

Then the subject remit the amount of money in conformity to a desired service or valuable information (S33), and verification is made to check if remittance has been made or nor, and if the amount remitted is adequate or not (S34). When remittance has been confirmed, the service or valuable information desired by the subject is sent to the subject, who receives the service or valuable information (S35). The result is associated with the ID data of the subject and is recorded and stored in the server 6 (S36).

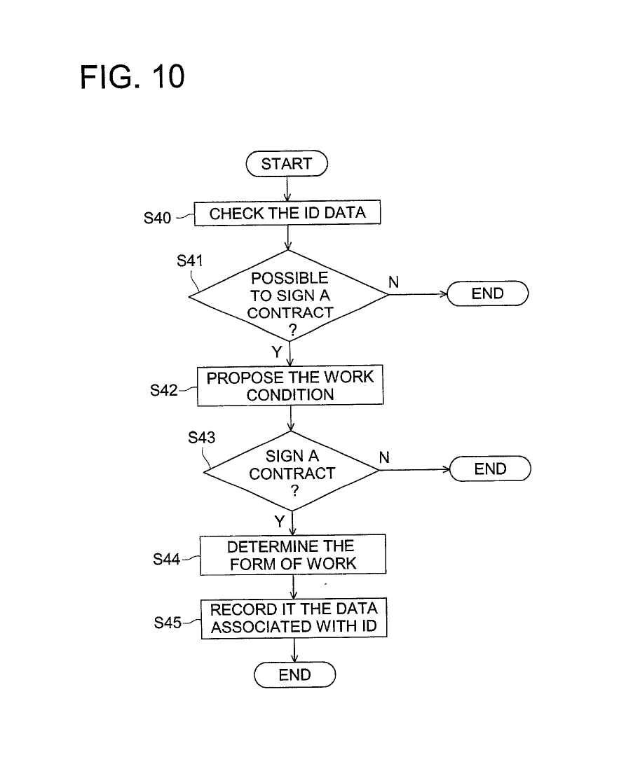

FIG. 10 is a flow chart representing an example of the processing system where a subject entering a virtual space finds employment in a shop (company) in the virtual space and work therefor.

Prior to signing a work contract with a desired shop (company), the ID data of the subject is checked (S40). Then based on the result of checking, the system determines if the subject is eligible or not (S41). If he is eligible, the work conditions of the shop (company) is presented to the subject (S42). The subject studies the proposed work conditions determined if he can sign the work agreement with the shop (company) (S43). Then work contract is signed between the subject and the shop (company). When the contract takes effect, a specific form of work is determined for the subject (S44). Thus, employment of the subject at the shop (company) in virtual space is determined, and work in virtual space is enabled. These results are associated with the subject ID data, and are recorded and stored in virtual space server 1 (S45).

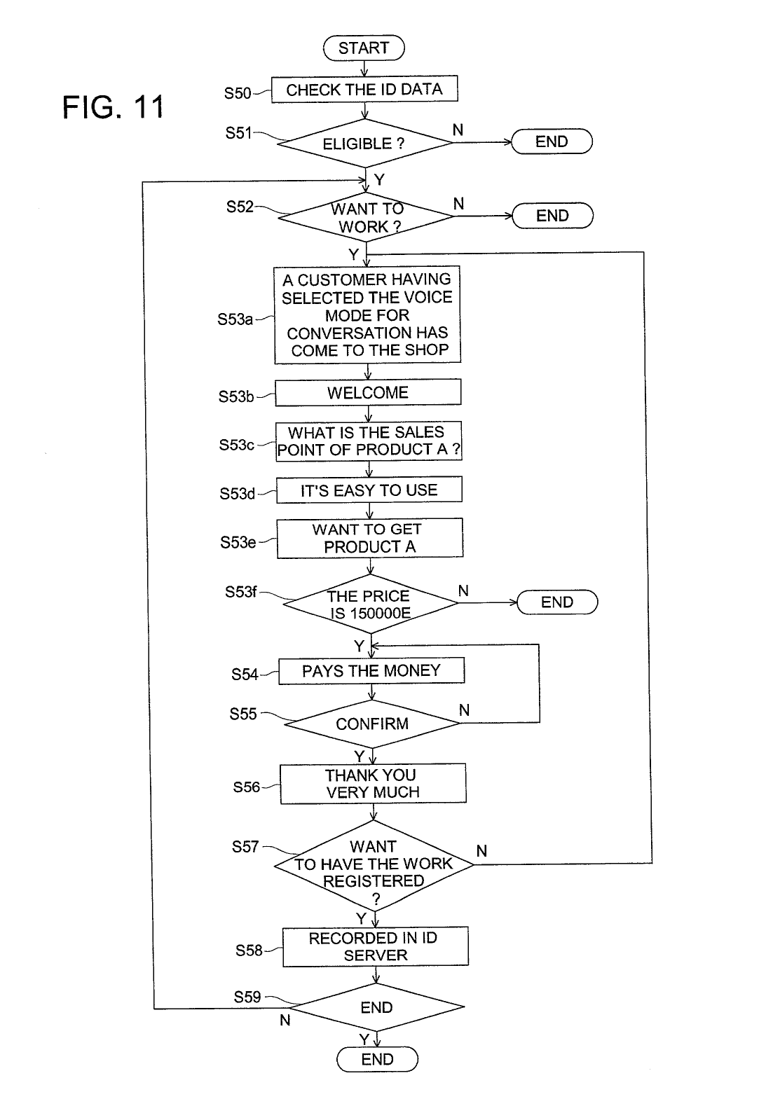

FIG. 11 is a flow chart representing an example of the processing system wherein a subject entering the virtual space keeps watch of a shop in virtual space in his activity in virtual space.

The subject ID data is checked first (S50). Then based on the result of checking, the system determined if the subject is eligible or not (S51). If he is eligible, he is asked if he wants to work at the shop (S52). He is willing to work for the shop. So he is employed and is now keeping watch of the shop. Then a customer has come to the shop, who selects the voice mode for conversation on the system (S53a). The subject sends a signal (or sound) to welcome the customer (S53b). The customer asks, “What is the sales point of product A?” (S53c). “It's easy to use”, replies the subject (S53d). The customer sends a message saying, “I want to get product A” (S53e). The subject keeping watch of the shop says, “The price is 150000E” (S53f). If the customer agrees to this proposal, he makes payment (S54). The shop keeper confirms it (S55), and sends a message which says, “Thank you very much” (S56).

Lastly, the system asks if the work of the shop keeper is to be recorded or not (S57). After it has been confirmed that recording is required, the information is associated with the ID and is recorded and stored in ID server (S58). The process is now complete (S59).

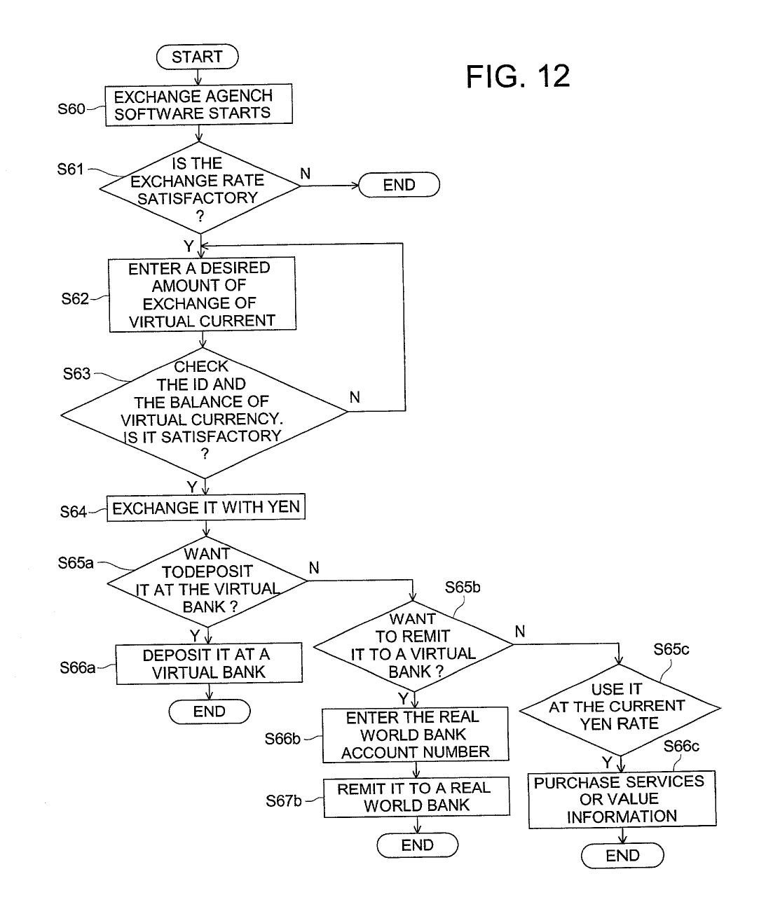

FIG. 12 is a flow chart representing an example of the processing system for conversion of virtual currency into yen;

When exchange agency software has started, the exchange system starts (S60). The exchange rate at the current time point is indicated and is confirmed (S61). Upon confirmation of the exchange rate, a screen appears wherein the amount of virtual current which the subject desires to be exchanged with yen is entered and displayed. The subject enters the desired amount for exchange (S62). After the desired amount is entered, the subject ID data and the balance of virtual currency of the subject associated with the ID are checked. The system determines if the desired amount is adequate or not as compared with the balance of the virtual currency of the subject (S63). If the desired amount is adequate as a result of balance checking, the virtual current is exchanged with yen in conformity to exchange rate (S64).

The following describes how yen is processed: For example, decision is made as to whether yen is deposited at a virtual bank in virtual space (S65a), is sent to a real world bank where it is deposited (S65b) or is kept in virtual space is used to get services or valuable information (S65c). If yen is to be deposited at a virtual bank, it it remitted to a virtual bank where it is deposited (S66a). When yen is to be deposited at a real world bank, the account number at the real world bank of the subject is entered (S66b), and yen is sent on-line to the real world bank by verification of the number (S67b). Further, when the money is to be used to get services or valuable information. The yen is used for payment when receiving services or valuable information (S66c).

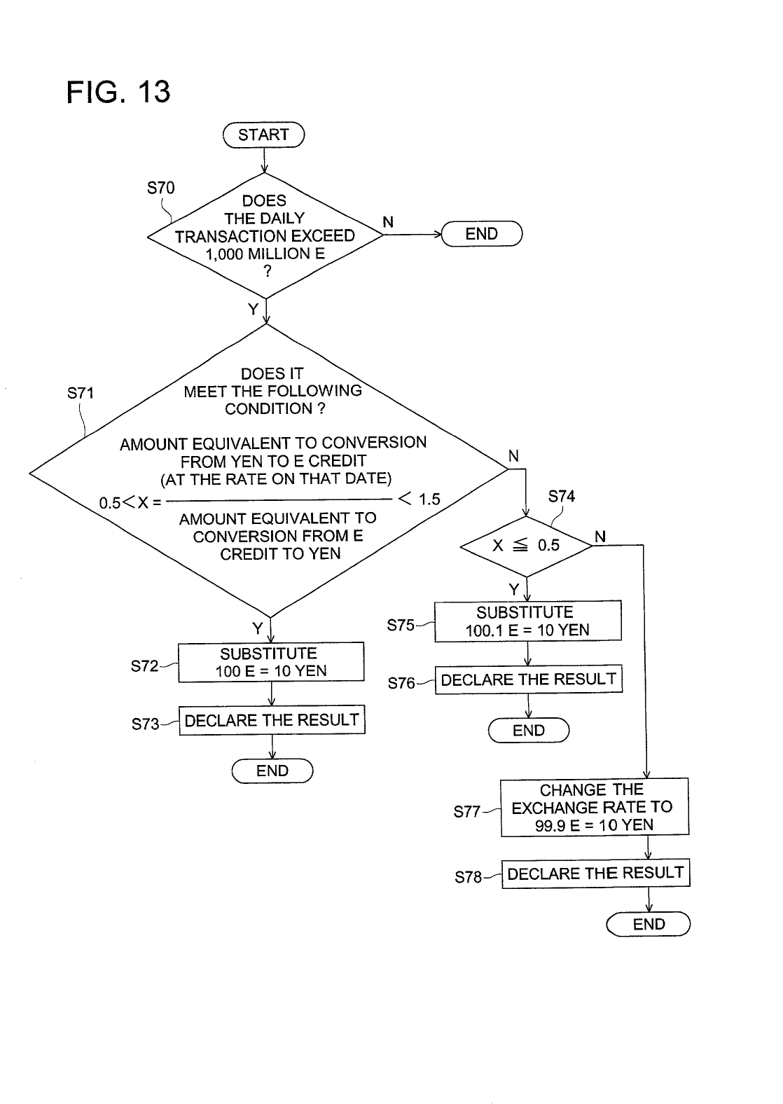

FIG. 13 is a flow chart representing an example of the processing system to determine the exchange rate for conversion of virtual currency into yen;

When exchange rate decision software has started, the exchange system starts. Verification is first made to check if the daily transaction exceeds 1,000 million E or not (S70). If the daily transaction exceeds 1,000 million E, the following equation is determined (S71).

Equation 1

$$0.5 < X = \frac{\text{Amount equivalent to conversion from yen to} \text{E} \text{credit (at the rate on that date)}}{\text{Amount equivalent to conversion from} \text{E} \text{credit to yen}} < 1.5 \qquad Equation 1$$

If the value is kept within the above range, the exchange rate is 100E=10 yen (S72), and this rate is displayed (S73).

In the meantime, when the value is not kept within the range, verification is made to check if X≦0.5 or not (S74).

If X≦0.5, the rate is changed to 100.1 E to 10 yen (S75). If 1.5≦X, the rate is changed to 99.9E to 10 yen (S77). Each rate is declared (S76 and S78).

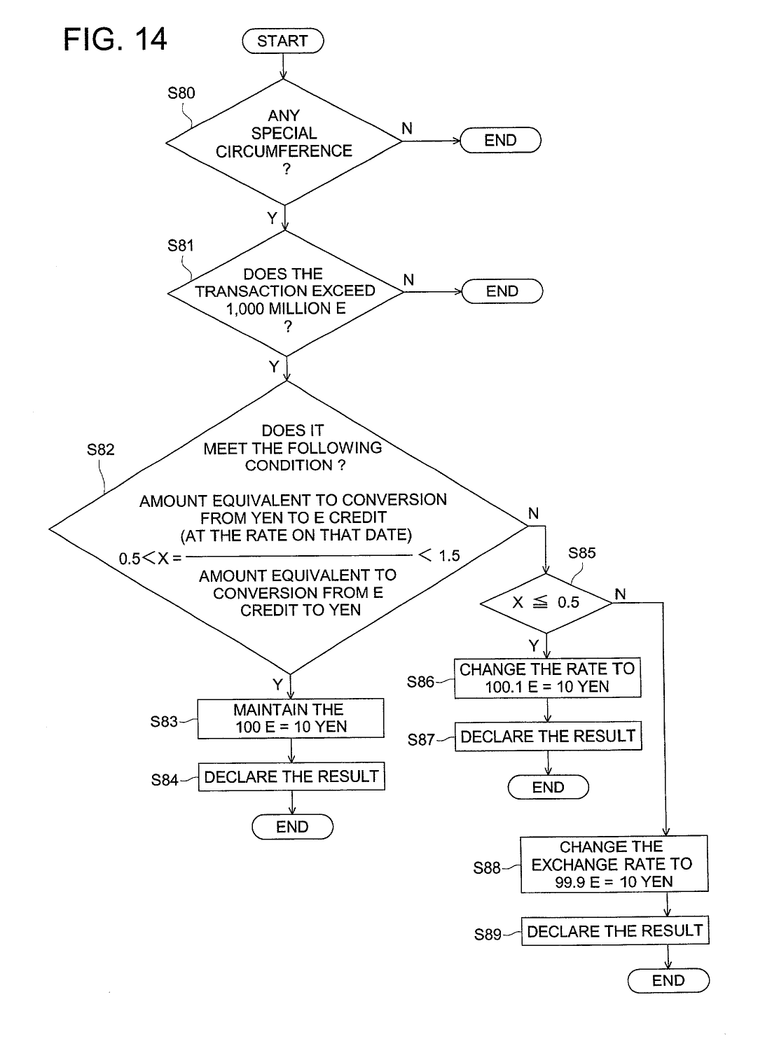

FIG. 14 is a flow chart representing an example of the processing system to change the exchange rate for conversion of virtual currency into yen.

When exchange rate change software has started, the exchange system starts. Verification is first made to check if there is any special circumstance in changing the exchange rate or not (S80). In other words, the system checks if imbalance occurs due to large-quantity transaction or the like. If there is no special circumference, verification is made to see if the daily transaction exceeds 1,000 million E or not (S81). If it exceeds 1,000 million E, the following equation is determined (S82).

Equation 2

$$0.5 < X = \frac{\text{Amount equivalent to conversion from yen to} \text{E} \text{credit (at the rate on that date)}}{\text{Amount equivalent to conversion from} \text{E} \text{credit to yen}} < 1.5 \qquad Equation 2$$

If the value is kept within the above range, the exchange rate of 100E=10 yen is maintained without being changed (S83), and this rate is displayed (S84).

In the meantime, when the value is not kept within the range, verification is made to check if X≦0.5 or not (S85).

If X≦0.5, the rate is changed to 100.1 E to 10 yen (S86). If 1.5≦X, the rate is changed to 99.9E to 10 yen (S88). Each rate is declared (S87 and S89).

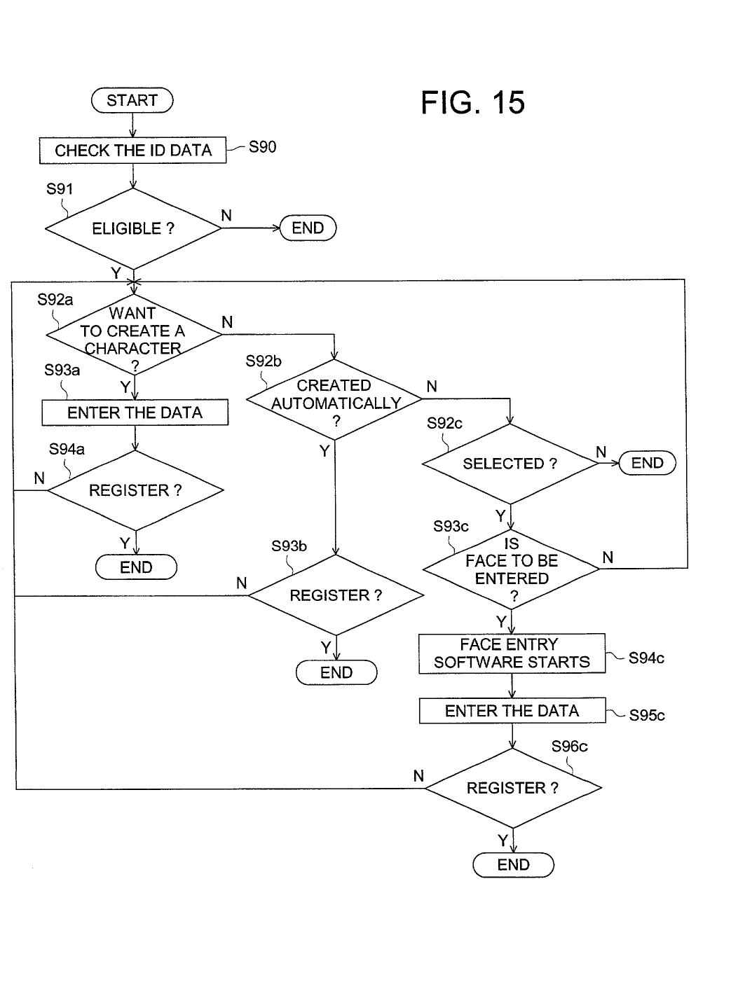

FIG. 15 is a flow chart representing an example of the processing system to determine self-image in virtual space.

This system is used, for example, to create a self-image when taking part in the school and circle in virtual space, but the use is not restricted thereto.

In FIG. 15, the ID data is checked (S90). The system checks if the subject is eligible or not (S91), and if a character is to be created or not (S92a). If a character is to be created, the required data is entered (S93a). Then confirmation is made to see if the entry is to be registered or not, and it is registered after making sure that registration is required (S94a). When the self-image is created automatically, confirmation is made again to see if it is to be created automatically (S92b). Verification is made to check if the automatically created self-image is to be registered or not, and it is registered after making sure that registration is required (S93b). When a character is selected, confirmation is made to see if character information is selected or not (S92c). If the response is affirmative, verification is made to see if the face is to be entered or not (S93c). When the reply is affirmative, face entry software starts (S94c), and the face data is entered in conformity to face entry software (S95c). It is registered (S96c) after making sure that registration is required.

### EXAMPLES

The following describes the examples of the economic data processing system in a virtual space according to the present invention:

### Example 1

This example shows the case where economic activities related to video in virtual space.

Mr. A (with his ID registered in the virtual space server) has a terminal. To enter virtual space, he accesses the Internet.

His ID is checked by a terminal server. Since it has been registered already, he is immediately connected to the virtual space server, and he is now placed in virtual space.

Mr. A is interested in a photo studio, and has been looking for it on web pages in virtual space.

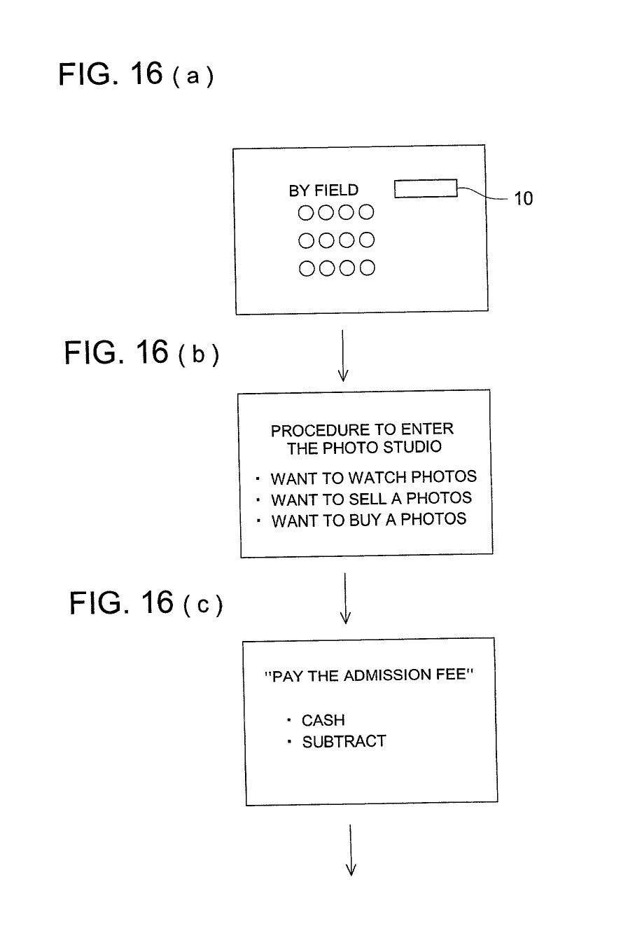

A screen shown in FIG. 16 (A) is displayed at first. This drawing shows a search screen by field. If the word “Photo Studio” is entered in the search word entry unit 10 using a search engine, a screen appears as shown in FIG. 16 (B). The screen of FIG. 16 (B) indicates how to enter the photo studio. It shows three words to be selected; “Want to watch photos”, “Want to sell a photo” and “Want to buy a photo”.

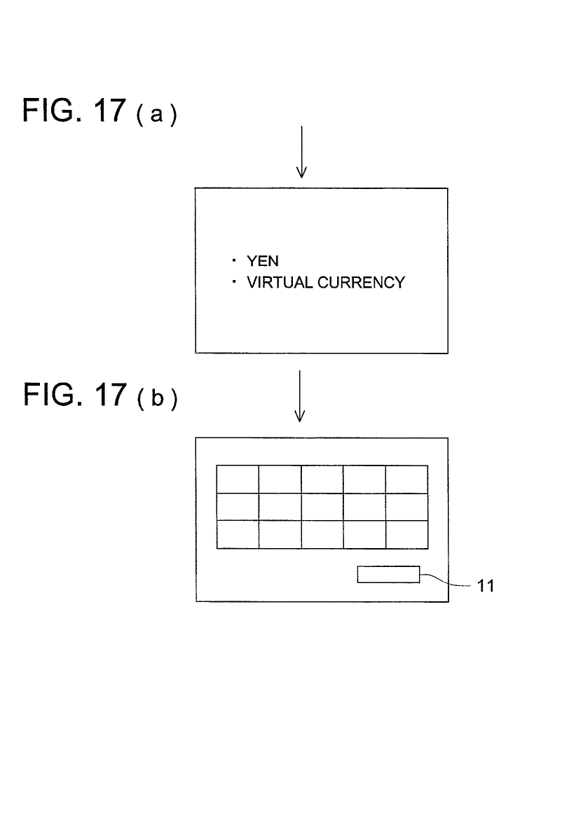

If he clicks “Want to watch Photos”, a screen of FIG. 16 (C) appears. The screen of (C) indicates “Pay the admission fee”. A selection screen also appears to indicate the method of payment which is either “Cash” or “Subtract”. If “Cash” is selected, a selection screen also appears to indicate selection between “Yen” or “Virtual Currency” as shown in FIG. 17 (A).

If “Virtual Currency” is selected, a screen appears to indicate “Pay 100E” (not illustrated). If “Cash” is selected, a selection screen also appears to indicate “Pay 50 yen” (not illustrated). If the specified mount is paid to the virtual bank, an image is sent back from the bank in response with the message that money has been received.

When “Subtract” is selected in FIG. 16(C), a Saving Account Input screen appears. If the account number is entered, the manager asks if the amount can be subtracted or not. After making sure that it can be subtracted. The amount is put into the database of the exchange server, and the Incoming account column, Outgoing account column and Balance column are filled to keep record of the transaction.

When payment has been confirmed in this manner, the screen indicates the message “Welcome”. Then a 15-frame photographic digital image is displayed as shown in FIG. 17 (B). If the number of images has exceeded 15, additional frames can be displayed. If there is any image of particular interest among the images (digital images) shown in the image frame, that image alone can be enlarged.

After viewing the photos, click on the character “End” 11 in FIG. 17 (B) to terminate viewing. The screen indicates the message ““Thank you very much. Come again very soon”.

The screen shown in FIG. 17 (B) indicates the name of the photographer, date of filming, name of copyright holder. Further, the date of updating the photo is preferably indicated.

The screen displays are driven by software installed on the virtual space server and exchanger server.

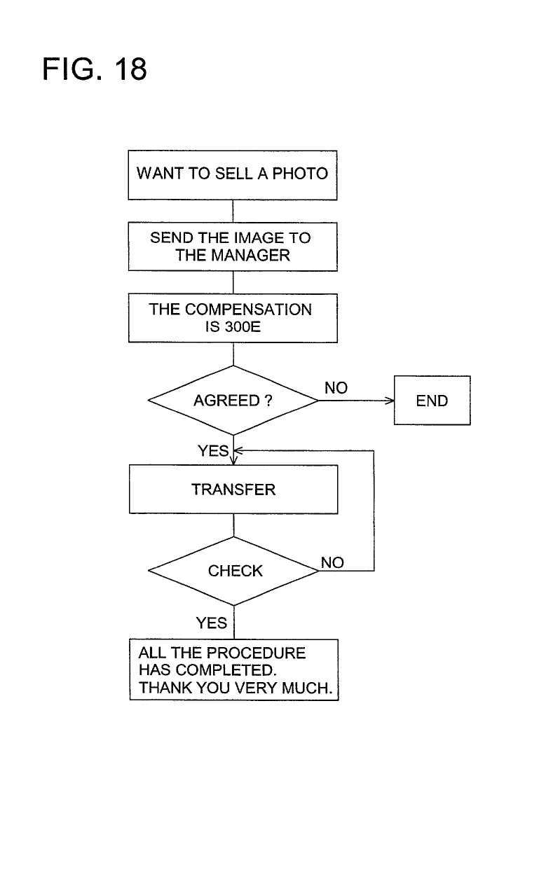

If “Want to sell a photo” is clicked on the screen in FIG. 16 (B), software shown in FIG. 18 will be driven to give the following screen displays.

The screen first displays the message “Send to the manager the image you want to sell.” Then if Mr. A agrees to the proposal that “compensation is 300E”, then the following message appears: “I will pay 300E to your account, so please confirm my payment.” If Mr. A has confirm it, he sends a message to that effect. Then send the image to the manager. After the manager has confirmed reception of the image, the whole process is now complete. It is also possible to make arrangement so that compensation is paid after confirmation of the image having been received.

Instead of asking for confirmation of the amount of compensation in the above description, a compensation list can be indicated to prompt selection therefrom.

If Mr. A has selected “Want to buy a photo” on the screen in FIG. 16 (3), he selects the screen which shows the photo he want to buy, from the screens shown in FIG. 17 (B) for photo watching. If there is no screen showing his photo, make a further search to find out the screen which shows his photo. The amount of compensation (sales price) is determined between Mr. A and manager. It will be convenient to have a declared price determined in advance. To increase the number of the photo buyers and activate the virtual economy, it will be effective to to set the amount of compensation lower than that in actual economic society.

### Example 2

The following describes a specific example of selling the image owned by Mr. A in Example 1.

The web page of the manager carries an advertisement of purchasing the image of digital information. Mr. A accesses the virtual space, then accesses the web pages of a photo studio to find out the purchase advertise.

Mr. A sends to the manager via the Internet the digital image of a landscape photo recently taken. The manager sends it to the terminal of the photo studio via the Internet.

The price of the digital image is preset at the digital data of 100 unit (hereinafter referred to as “100 E credit”).

The amount is paid via the Internet using the electronic virtual currency stored in the manager's computer.

The account information of Mr. A and photo studio is stored in the database of the exchange server. Further, the earnings are recorded on the recording medium (e.g. credit card) owned by Mr. A.

### Example 3

Mr. A finds a want ad for private tutor on the electronic bulletin board in virtual space, and applies for the position. Since he succeeded in application, he works as a private tutor for one hour via the Internet to get 150 E credit as compensation thereof.

### Example 4

After retirement from the company, Mr. A is now working as a secretary for a politician. He has experience in political campaign for election, and has always been successful. Now he is not physically strong enough to attend the election campaign, so he cannot use his experience and knowhow, and cannot get earnings.

Use of this system allows him to get earnings. Namely, his knowhow in election campaign can be provided as valuable information to the virtual community.

His knowhow in election campaign is converted into electronic form and is sent to the manager to be stored in the manager's computer. The knowhow is protected so that it can be disclosed only to those who have acquired a specific password and cryptography. Without such protection, knowhow will be used free of charge. A specific password and cryptography can be obtained by paying deposit in conformity to the agreement with the manager.

There is much demands for knowhow in election campaign, which brings about a great deal of compensation. Mr. A is in a position to get great wealth. The system according to the present invention is effective and characterized in that in that a physically handicapped person get property value by offering his knowledge and knowhow of high property value.

### Example 5

Mr. A is planning to establish a company in virtual space. He called for shareholders via the Internet wherein 1,000 shares are issued with each share priced at 200 E credit. Mr. A has the responsibility for management independently of the number of shares. The general meeting of shareholders is held in virtual space once a year. Dividend is three percent of the profits. E credit is used for all payment.

All share certificates are issued in digital form and are sold via virtual Internet. Virtual currency is used for all the dealing of shares. The compensation gained by working in virtual space is used for all such currency. This makes it possible make a fortune using the compensation gained by working in virtual space.

### Example 6

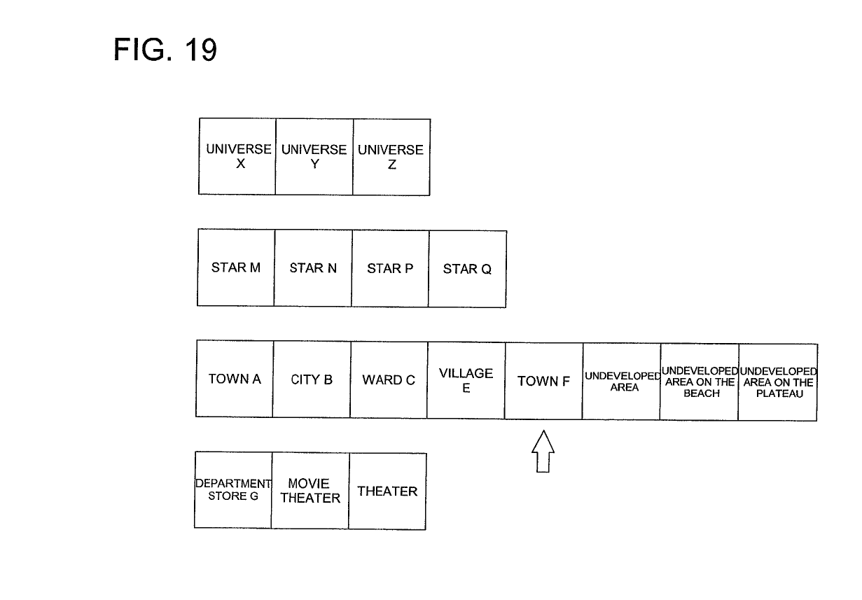

Mr. A accesses the Internet. Using the screen on web pages, he finds out the screen shown in FIG. 19. This screen shows the unit of the space where the system according to the present invention is introduced.

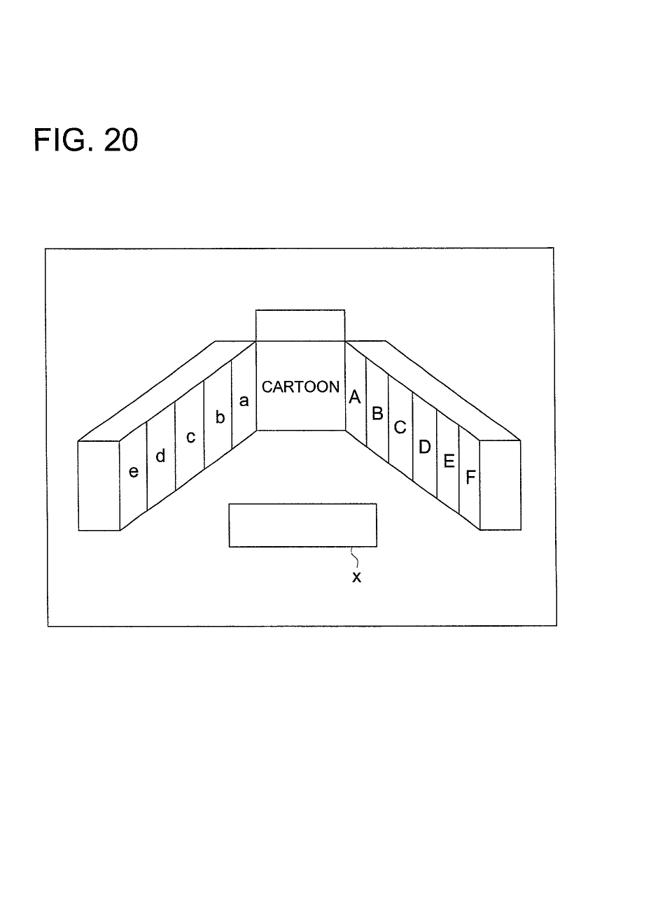

Mr. A clicked on Town F. The screen changes to show FIG. 20. This screen indicates a community in front of the station. The system according to the present invention is introduced in this community. A cartoon shop is found at the center of the screen, On the left of the screen, he find a tutor dispatch office a (recruiting tutors), life consultant b, photo studio (recruiting personnel) c, vacant lot d (priced at 500 E) and hotel e. On the right of the screen a health consultant office A, scenario writer's school B, hobby square C, artist circle D, golf center E and bar F.

The manager of this community is an owner of the photo studio, who has a computer managing the Internet. A bank and guarantee institution (not illustrated) are installed on the Internet.

To enter the cartoon shop, Mr. A. clicked on it. As shown in FIG. 120, a screen appears to show a want ad X hunting for a manager. He applies for the position and paid the contract money to become the manager. Thus, he started a new business, using his stored virtual currency (1000E) as capital.

Mr. B wants to take part in the artist circle, and check for membership requirements. He successfully becomes a member and is now engaged in circle activities.

### Example 7

Mr. B with a handicapped leg is confined to a wheelchair. One day he accesses the virtual space according to the present invention. He finds buttons over the images for browsing course and membership course, and clicked on the browsing course to enter the virtual space. A screen appears so that he can select a country and city he want to visit. Entering still deeper, he reaches a virtual university of a virtual town. In the square of the university, he comes across about ten people talking among themselves, some on the bench and other standing. Using a mouse, Mr. B moves his own character on the image, and passes by four people talking while standing. Through the computer speaker, he hears these four people talking. They are discussing their side-jobs. Mr. B was interested in this space. Coming back to the initial screen, he clicks on the membership button. He signs an agreement with the system manager according to the present invention on the screen. Mr. B selects his image in virtual space from multiple models. For the face, however, he uses his favorite photo of himself and pastes it on the selected image. He studies the employment information and finds employment in a car purchase consultant company of town P in virtual space. To get the job, he signs an agreement with the consultant company. In this case, receiving a letter of guarantee from the manager of the system according to the present invention, he presents it to the consultant company. He works at the rate of 100E (digital value) per hour to explain the car to a visitor using a manual. If his job has led to the sales of a car, he gets a bonus of 5000 E. Customers visiting the virtual space appear as image characters pasted with a photo of the face. During the work, either face-to-face conversation by sound or text information can be selected.

After working in the virtual space, Mr. B received 7,500 E. To exchange it with real world money, he visits a virtual bank and has 727 yen (727.5 yen with all digits to the right of decimal point discarded) transferred into his real world bank account at an exchange of 100 E to 10 yen with a commission of 3 percent for the virtual bank. Now he has earned this amount through working.

The present invention provides a processing system and recording medium for economic data in a virtual space which offer a place to make an effective use of the experience and knowledge of the people left unused, awaken the latent power to create value, and encourage participation into the society.

The present invention also provides a processing system and recording medium for economic data in a virtual space which offer an opportunity of using for the benefits of the society the creativity of jobless persons and so-called part-timers who are making their living by irregular unspecified part time job.

The present invention also provides a processing system and recording medium for economic data in a virtual space which ensure an opportunity for any people to find employment without being restricted to a particular place and time, especially to a particular place.

The present invention also provides a processing system and recording medium for economic data in a virtual space which realize economic activities ensuring safe value distribution.

The present invention also provides a processing system and recording medium for economic data in a virtual space which allow indirect reflection of economic activities on the Internet upon the real world.

The present invention also provides indirect economic data in a virtual space to ensure that transactions on the Internet free from illegal actions can be reflected upon the real world.

The present invention also provides a processing system and recording medium for economic data in a virtual space which remove miscellaneous low-valued information from various types of information provided on the Internet free of charge in principle, and offer truly valuable information in a valuable form, wherein the system contains paid form of services basically.

The present invention also provides a processing system and recording medium for economic data in a virtual space which allow anybody to create social value without involving consumption of energy for transportation of humans or goods.

The present invention also provides a processing system and recording medium for economic data in a virtual space which permit quick display of the results of economic activities in virtual space and the balance of income and expenditure for each subject identified by the ID data in terms of virtual currency and or actual currency.

Disclosed embodiment can be varied by a skilled person without departing from the spirit and scope of the invention.

What is claimed is:

1. An economical data processing system, comprising:
means for forming a virtual space in use with a network which includes a plurality of computers connected to each other;
means for forming virtual currency which represents a value index in said virtual space; and
a virtual currency storing means for storing said virtual currency;
wherein said virtual currency is delivered in said virtual space.

2. The economical data processing system of claim 1, further comprising:
a valuable information storing means for storing valuable information representing value provided in said virtual space;
wherein said valuable information is delivered in said virtual space.

3. The economical data processing system of claim 2, wherein value of said valuable information is represented as value data, representing said virtual currency, in said virtual space; and said valuable information storing means stores said valuable information in relation with said value data.

4. The economical data processing system of claim 2, wherein said valuable information is exchangeable with said virtual currency in said virtual space.

5. The economical data processing system of claim 2, wherein said valuable information is represented as value data, representing said virtual currency, in said virtual space; further comprising:
a valuable information evaluation means for evaluating a value of said valuable information so as to generate said value data of said valuable information.

6. The economical data processing system of claim 2, further comprising:
a ID data generating means for giving ID data to a subject which delivers said virtual currency in said virtual space.

7. The economical data processing system of claim 6, further comprising:
a ID data judging means for judging whether or not said subject is allowed to make a connection with said virtual space in accordance with said ID data, and giving a permission to said subject to make a connection with said virtual space when said subject has said ID data with authenticity.

8. The economical data processing system of claim 6, wherein said ID data generating means gives said ID data to a subject which delivers said valuable information; and said valuable information storing means stores said valuable information in relation with said ID data.

9. The economical data processing system of claim 6, wherein said virtual currency storing means stores said virtual currency in relation with said ID data.

10. The economical data processing system of claim 1, further comprising:
a virtual currency evaluation means for evaluating said virtual currency in a value system of real currency.

11. The economical data processing system of claim 10, further comprising:
means for exchanging said virtual currency with said real currency in accordance with the evaluation result of said virtual currency evaluation means.

12. The economical data processing means of claim 2, wherein said valuable information is image information.

13. The economical data processing means of claim 1, wherein a subject is given said virtual currency as a reword for being restricted in said virtual space for a period of time.

14. An information processing apparatus, in use with an economical data processing system of a virtual space which is provided by a network of a plurality of computers connected to each other, comprising:
means for forming virtual currency which represents a value system in said virtual space;
wherein said virtual currency is delivered in said virtual space.

15. A recording media for recording a program of the economical data processing system of claim 1.
